(19) United States
(12) Patent Application Publication
(10) Pub. No.: US 2010/0103836 A1
(43) Pub. Date: Apr. 29, 2010

(54) Remote Optimizing Wireless Wan Modular Transmitter/Bridge

(75) Inventors: Michael E. Nagy, Tampa, FL (US); Thomas A. Butts, Tampa, FL (US)

Correspondence Address: SHUTTS & BOWEN, LLP, 100 S. ASHLEY DRIVE, SUITE 1500, TAMPA, FL, 33602, US

(73) Assignee: Accelerated Concepts, LLC, Tampa, FL (US)

(21) Appl. No.: 12/605,057

(22) Filed: Oct. 23, 2009

Related U.S. Application Data
(60) Provisional application No. 61/107,790, filed on Oct. 23, 2008.

(51) Int. Cl. H04L 12/26

(52) U.S. Cl. 370/252; 370/338

(57) ABSTRACT

The invention is a modular, optimizing transmitter/bridge device for optimizing placement of a transmitter/bridge for WWAN communication for one or more WWAN service providers, comprising a transmitter/bridge for WWAN communication, including software for identifying signals from the one or more WWAN service providers, a WWAN interface for providing WWAN service from a preselected WWAN service provider in electronic communication with the transmitter/bridge, a connection to a power source in electronic communication with the transmitter/bridge; and a signal strength indicator in electronic communication with the transmitter/bridge for indicating signal strength of a preselected WWAN service. The device will also have a signal strength indicator to allow for optimal placement for maximum wireless connectivity.

### CROSS-REFERENCE TO RELATED APPLICATION

This application relates to the same subject matter as co-pending provisional patent application Ser. No. 61/107,790, filed by the same applicant on Oct. 23, 2008. This application claims the Oct. 23, 2008 filing date as to the common subject matter.

### BACKGROUND OF THE INVENTION

1. Field of the Invention

The disclosure relates generally to a transmitter/bridge. More particularly, the present invention relates to a remote optimizing wireless wide area network (WWAN) modular transmitter/bridge.

2. Description of the Related Art

Today most IT equipment is placed in a secure section of a building. The secure location is typically near the center of a building. Therefore, the IT equipment is often surrounded with dense structures which reduce the ability of the IT equipment to perform some of its functions. For example, the inherent properties of the dense structures at secure locations make them typically the least desirable place for penetration of wireless transmissions such as IEEE 802.11 Standard Wireless Fidelity Local Area Networking (WiFi) and HSPA/EV-DO/LTE WWAN. Areas where wireless communications fail are known in the art as dead zones, and continuous, non-interrupted communications are essential for business and private communications, as well as emergency services. Lost and interrupted communications are frustrating and potentially dangerous when communications are disrupted. Also, loss of business communications may result in incomplete transactions, loss of important business and financial data and similar problems.

Another problem with current IT equipment is that it is often difficult to determine an optimized location for a wireless transmitter. All wireless communication is invisible, tasteless, and emits no noise. Without a tool for detecting wireless transmissions and the strength of those transmissions, the user is forced to use a trial and error method of placing the transmitter in a location, testing the application, and then moving the transmitter to a new potential target location.

In addition, sometimes the needs of an individual or business are preferred to be met with more than one data stream. For example, a business may desire that email communications come through one data stream, while financial data or bulk data transmissions are communicated by a separate data stream. Furthermore, the individual or business may wish to have redundant communication lines, even while the IT equipment remain secure and surrounded by dense structures which can impede communications.

An optimizing modular, transmitter/bridge with an optimal placement indicator is needed. In addition, the optimizing transmitter/bridge may have modular USB connectors, such as an Ethernet jack. The optimizing transmitter bridge may also be remotely powered, or have the ability to be powered by a battery and by a remote power source. The optimizing transmitter/bridge may also have internal software to allow it to be compatible with several wireless systems. The optimizing transmitter/bridge also includes associated hardware to assure compliance with advances in technology and interoperability across different wireless carriers.

### BRIEF SUMMARY OF THE INVENTION

The invention is a modular optimizing transmitter/bridge, having a transmitter/bridge, a WWAN interface and a power connection. Remote power may be supplied using standard Power Over Ethernet (PoE) and/or Passive PoE or similar means. The device will be transparent to the end device and the wireless network. The device will also have a placement indicator to allow for optimal placement for maximum wireless connectivity.

The user may insert the WWAN interface in a modular slot and plug in temporary battery powered PoE adapter. User may then will roam through the installation space using the location indicator to locate optimal placement. Once an optimal location is found the user may secure the optimizing device using a wall mount, magnetic base, or other means. The user may then run a cable from the main gateway to the wireless bridge. If needed, the user may insert a POE injector to power the device remotely. Thus, the device may appear transparent to the wireless network and the main gateway or provide separate router functionality.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

### BRIEF DESCRIPTION OF THE DRAWINGS

The accompanying drawings, which are incorporated in and constitute part of this specification, illustrate an embodiment of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic diagram of an embodiment of the invention.

FIG. 2 is a schematic diagram of an embodiment of the invention as installed.

### DETAILED DESCRIPTION OF THE INVENTION

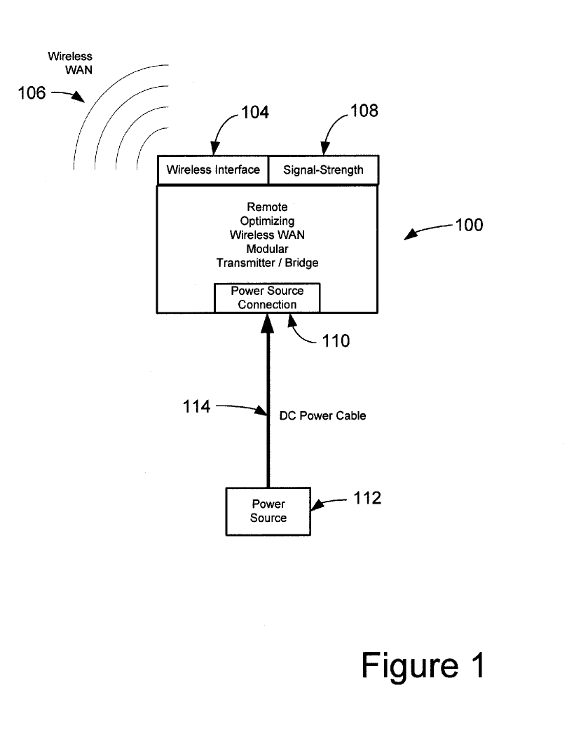

The present invention is an optimizing transmitter/bridge, shown generally in FIG. 1 at 100.

The optimizing transmitter/bridge 100 incorporates a transmitter/bridge 102. The transmitter/bridge 102 includes software for identifying signals from one or more WWAN service providers. The transmitter bridge may be one that has the functionality of routers such as those manufactured by NetGate, McAfee or Cisco. Furthermore, the transmitter/bridge may be incorporated within the functionality of a personal computer such as a PC.

The optimizing transmitter/bridge 100 also includes a WWAN Interface 104 for WWAN service 106 by a WWAN service provider. The WWAN Interface 104 may be internal or external to the optimizing transmitter/bridge 102, and typically consists of a 3G Wireless USB Modem. The WWAN interface 104 may include a modular slot so that the WWAN interface 104 of several WWAN service providers may be interchanged, so that the user may use the optimizing transmitter/bridge 100 with a preselected WWAN service provider. The optimizing transmitter/bridge 100 also incorporates a signal strength indicator 108 for a WWAN service 106. The signal strength indicator 108 may be through an LED display, an LCD display, or by other means known in the art.

The optimizing transmitter/bridge 100 further includes a connection to a power source 110. The connection to the power source 110 may be an Ethernet Jack or similar connection which allows both DC power and data communication over a single cable, such as Category 5 cable. For example, as shown in FIG. 1, the connection 110 may be connected to a power source 112 such as a DC power source or a battery via a DC power cable 114. In another embodiment, the optimizing transmitter/bridge 100 includes a battery port whereby power may also be provided to the optimizing transmitter/bridge 100 by placing a battery internally or on an exterior surface of the optimizing transmitter/bridge 100. The optimizing transmitter/bridge may alternatively have both a battery port and a power source connection. However, other means for powering the optimizing transmitter/bridge 100 known in the art are also contemplated.

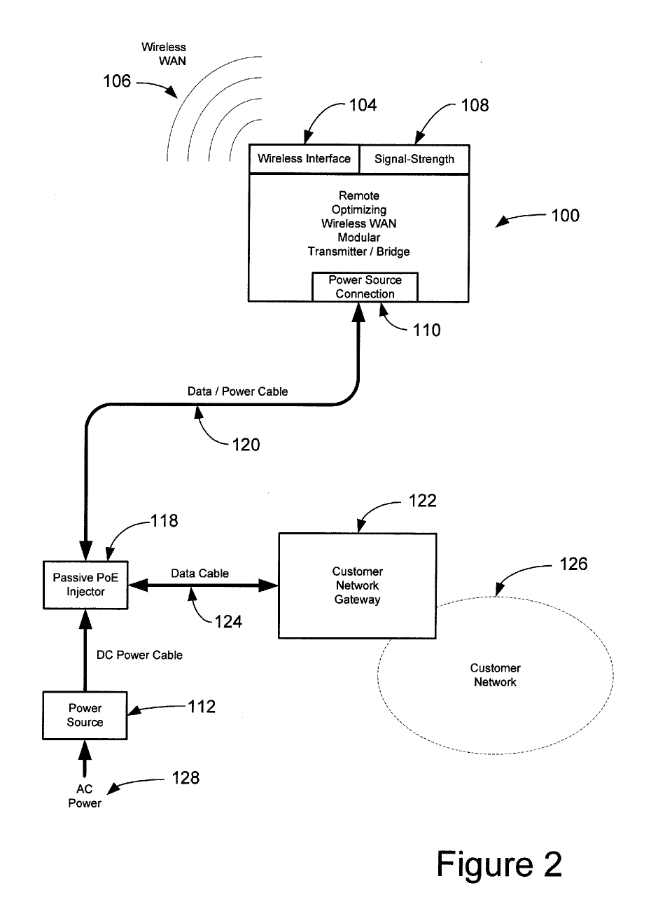

Another embodiment of the subject invention is illustrated in FIG. 2. As shown, the optimizing transmitter/bridge 100 may be powered by a power source 112 such as a DC power source connected to a standard AC power source 116. The power source 112 may then be connected to a Power over Ethernet (PoE) injector 118, such as a passive PoE injector. The power source may then be connected to the PoE injector 118 via a power cable. The PoE injector 118 functions to allow both data and power transmission via a data and power cable 120. The data and power cable 120 may then be in communication with the transmitter/bridge 102 via the connection to the power source 110.

As also shown in FIG. 2, the optimizing transmitter/bridge 100 may perform as a transparent network bridge for a preselected customer network. In the configuration shown, a customer network gateway 122 may be in communication with a PoE injector 118. The communication may be via a data cable 124. In an alternative embodiment, the data cable 124 may supply the power to the PoE injector 118. The customer network gateway 122 thus provides communication between the user and the user's preselected customer network 126.

In the configuration shown in FIG. 2, the optimizing transmitter/bridge 100 in operation essentially connects a customer's network gateway 122 to a preselected WWAN service 106. In usual practice, the customer network gateway 122 is generally located in a secure site. Thus, the optimizing transmitter/bridge 100 provides optimized WWAN service to a customer via the customer's preselected network 126. This is advantageous because the optimizing transmitter/bridge (located in an area with good signal strength from the WWAN) may be a substantial distance away from the customer network gateway 122, which may be located where signal strength from the WWAN is inadequate.

Thus, the user's access to the internet via a customer network gateway 122 may have a land connection or a separate WWAN connection to a preselected network, and the user may use the optimizing transmitter/bridge 100 as a backup to the land connection or separate WWAN connection. Furthermore, the optimizing WWAN is able to send and receive WWAN communication through an Ethernet connection. Also, the customer network gateway 122 may serve as a separate connection to the customer's access to the internet for separate data streams. In addition, the customer network gateway 122 may be in electronic communication with another WWAN interface, whereby the optimizing transmitter/bridge becomes the primary receiver of WWAN signal and the other WWAN interface becomes a backup receiver.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

What is claimed is:

1. An optimizing transmitter/bridge device for optimizing placement of a transmitter/bridge for WWAN communication for one or more WWAN service providers, comprising:
a transmitter/bridge for WWAN communication, including software for identifying signals from the one or more WWAN service providers;
a WWAN interface for providing WWAN service from a preselected WWAN service provider in electronic communication with the transmitter/bridge;
a power source connection in electronic communication with the transmitter/bridge; and
a signal strength indicator in electronic communication with the transmitter/bridge for indicating signal strength of a preselected WWAN service.

2. The device of claim 1, wherein the connection to the power source comprises a jack for an Ethernet connection.

3. The device of claim 1, wherein the software is embedded as firmware in the transmitter/bridge.

4. The device of claim 1, wherein the software for identifying the signals is remotely manageable through transmission via the WWAN service.

5. A computer implemented system for optimizing WWAN service, comprising:
An optimizing transmitter/bridge, including,
a transmitter/bridge for WWAN communication, including software for identifying signals from more than one WWAN service provider;
a WWAN interface for providing the WWAN service from a preselected WWAN service provider in electronic communication with the transmitter/bridge;
a power source connection in electronic communication with the transmitter/bridge; and
a signal strength indicator in electronic communication with the transmitter/bridge for indicating signal strength of the preselected WWAN service provider; and
a PoE injector,
whereby the transmitter/bridge is in electronic communication with the PoE injector.

6. The system of claim 5, wherein the PoE injector is a passive PoE injector.

7. The system of claim 5, further comprising a customer network gateway, wherein the PoE injector is in electronic communication with a customer network gateway to a customer network.

8. The system of claim 5, wherein the software is embedded as firmware in the transmitter/bridge.

9. The system of claim 5, wherein the software for identifying signals is remotely manageable through transmission via WWAN service from the preselected WWAN service provider.

10. The system of claim 7, wherein optimizing transmitter/bridge provides a backup link for the customer network gateway to the customer network.

11. The system of claim 7, wherein optimizing transmitter/bridge provides a separate link for the customer network gateway to the customer network.

12. The system of claim 10, wherein the preselected WWAN service and the customer network are provided by a singe communications service.

13. The system of claim 11, wherein the preselected WWAN service and the customer network are provided by a singe communications service.
